(19) United States
(12) Patent Application Publication
(10) Pub. No.: US 2007/0135188 A1
(43) Pub. Date: Jun. 14, 2007

(54) Mobile terminal device

(75) Inventors: Masamichi Watanabe, Kawasaki (JP); Tatsuhito Araki, Kawasaki (JP); Yoshiaki Kato, Kawasaki (JP); Hidekatsu Kobayashi, Kawasaki (JP); Yoshifumi Kajiwara, Kawasaki (JP); Wataru Murata, Kawasaki (JP); Hiroaki Matsuda, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/390,468

(22) Filed: Mar. 28, 2006

(30) Foreign Application Priority Data
Dec. 13, 2005 (JP) 2005-359477

(51) Int. Cl. H04M 1/00

(52) U.S. Cl. 455/575.3

(57) ABSTRACT

In a mobile terminal device, a movable-side case is coupled to a fixed-side case by a coupler such that the movable-side case freely overlaps the fixed-side case. The movable-side case houses electronic components including a display; and includes a box-shaped external case that is made of magnesium alloy, having side walls of a height sufficient for housing the electronic components, and including an opening from which the display is exposed, and a panel that is flat, covers a displaying surface of the display, and is fixed to the opening.

### BACKGROUND OF THE INVENTION

1. Field of the Invention

The present invention relates to a mobile terminal device including a movable-side case that is coupled to a fixed-side case and that freely overlaps the fixed-side case.

2. Description of the Related Art

With increasing needs for compact mobile phones having large, easily viewable display screens, mobile phones including a movable-side case coupled to a fixed-side case have become popular. The movable-side case freely overlaps the fixed-side case by, for example, being folded at a hinge. The fixed-side case includes various keys and the movable-side case includes a display such as a liquid crystal display (LCD). The fixed-side case and the movable-side case each houses various electronic components such as a circuit board. Japanese Patent Application Laid Open Nos. 2003-347755 and 2001-185865 disclose such mobile phones. The fixed-side case and the movable-side case each has a split structure including a front case and a back case sandwiching a circuit board, and at least one of the front case and the back case is made of light-weight, high-strength magnesium alloy.

FIG. 6 is a perspective view of the conventional folding mobile phone, FIG. 7 is an exploded perspective view of a movable-side case 103 and internal components, FIG. 8 is a cross-sectional side view of the movable-side case 103, FIG. 9 is a partial cross-sectional front view of the movable-side case 103, and FIG. 10 is an exploded front view of the movable-side case 103.

The mobile phone includes a fixed-side case 101 with keys 100 having a 10-key numeric keypad, the movable-side case 103 including an LCD 102, and a hinge mechanism 104 that foldably couples the fixed-side case 101 and the movable-side case 103. The fixed-side case 101 has a split structure of a fixed front case 105 on a side of the keys 100 and a fixed rear case 106 on a back side. Similarly, the movable-side case 103 has a split structure of a movable front case 107 on a side of the LCD 102 and a movable rear case 108 on a back side screwed together, as shown in FIG. 8.

The movable rear case 108 is a thin box made of resin, including side walls 108a with a low height sufficient for housing a circuit board 109. The movable front case 107 is made of magnesium alloy, and houses the LCD 102 having a panel structure and held by an LCD holder 110 laminated on the circuit board 109. The movable front case 107 is a frame including an opening 107a, from which a display 102a of the LCD 102 is exposed, and a movable-side hinge part 104a of the hinge mechanism 104.

The mobile phone includes a sub-LCD module 111 functioning as a supplementary display on a back side of the movable-side case 103, and a flexible cable 112 that connects the sub-LCD module 111 to the circuit board 109. The movable rear case 108 includes an opening 108b on a bottom surface to which the sub-LCD module 111 is attached. A rear panel 113 covers the opening 108b. The mobile phone has a twin camera structure including an out-camera module 115 with a charge-coupled device (CCD) structure held by an out-camera holder 114 and connected to the circuit board 109, and an in-camera module 116 with a CCD structure held by a holding part 110a of the LCD holder 110 and connected to the circuit board 109. An attachment part 108c to which the out-camera module 115 is attached is located on the bottom surface of the movable rear case 108. An out-camera panel 117 and a camera cover 118 covers the attachment part 108c. The mobile phone includes a plurality of, for example, three one-touch keys 119 and a corresponding one-touch key module 120 for making a phone call with a one-touch operation. To use the one-touch operation, telephone numbers frequently used, such as a home number or family's numbers, are registered beforehand. The movable front case 107 includes openings 107b from which the one-touch keys 119 are exposed, and an opening 107c from which the in-camera module 116 is exposed. A transparent panel 121 covering portions around the opening 107a is attached on the outside of the movable front case 107.

With the advancement of compact and multifunctional mobile phones, there is a strong demand to improve strength and reduce cost. The conventional mobile phone does not sufficiently address these demands, and requires further improvement.

### SUMMARY OF THE INVENTION

It is an object of the present invention to at least solve the problems in the conventional technology.

According to an aspect of the present invention, a mobile terminal device includes a fixed-side case; and a movable-side case that is coupled to the fixed-side case by a coupler such that the movable-side case freely overlaps the fixed-side case, and that houses electronic components including a display; where the movable-side case includes an external case that is box-shaped, is made of magnesium alloy, has side walls of a height sufficient for housing the electronic components, and including an opening from which the display is exposed, and a panel that is flat, covers a displaying surface of the display, and is fixed to the opening.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a mobile phone according to an embodiment of the present invention;

FIG. 2 is an exploded perspective view of a movable-side case shown in FIG. 1;

FIG. 3 is a cross-sectional side view of the movable-side case;

FIG. 4 is a partial cross-sectional front view of the movable-side case;

FIG. 5 is an exploded front view of the movable-side case;

FIG. 6 is a perspective view of a conventional mobile phone;

FIG. 7 is an exploded perspective view of a movable-side case shown in FIG. 6;

FIG. 8 is a cross-sectional side view of the movable-side case;

FIG. 9 is a partial cross-sectional front view of the movable-side case; and

FIG. 10 is an exploded front view of the movable-side case.

### DETAILED DESCRIPTION OF THE PREFERRED EMBODIMENTS

Exemplary embodiments of the present invention will be explained in detail below with reference to accompanying drawings. The present invention is not limited to these embodiments.

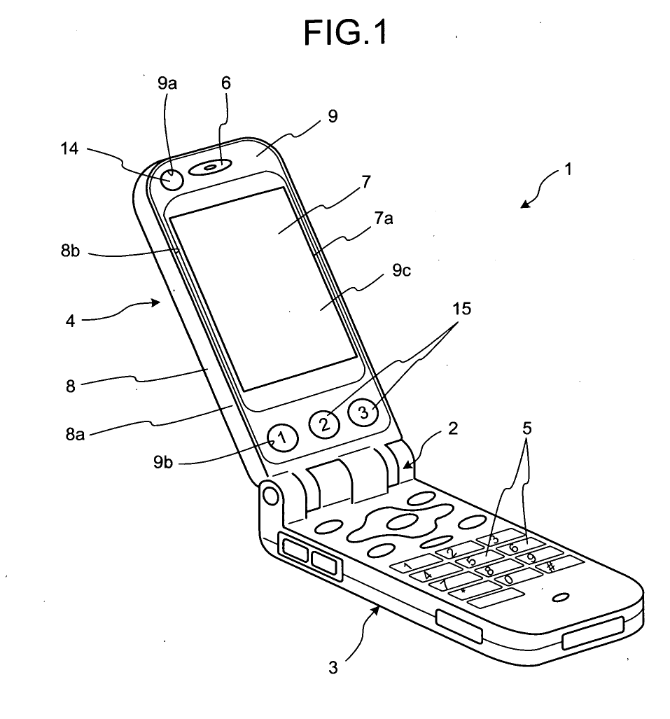

FIG. 1 is a perspective view of a mobile phone 1, which is a mobile terminal device, according to an embodiment of the present invention. The mobile phone 1 includes a fixed-side case 3 and a movable-side case 4 that is the same size as the fixed-side case 3. A hinge 2 foldably couples the fixed-side case 3 and the movable-side case 4. The fixed-side case 3 used as a mouthpiece includes various operation keys 5 including dial keys and function keys, and the movable-side case 4 used as an earpiece includes a receiver 6 incorporating a speaker and a display 7a of a built-in LCD 7.

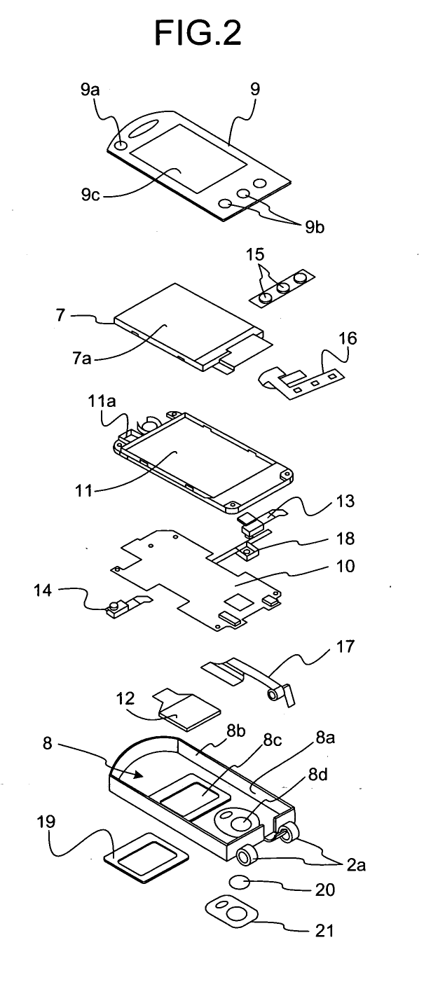

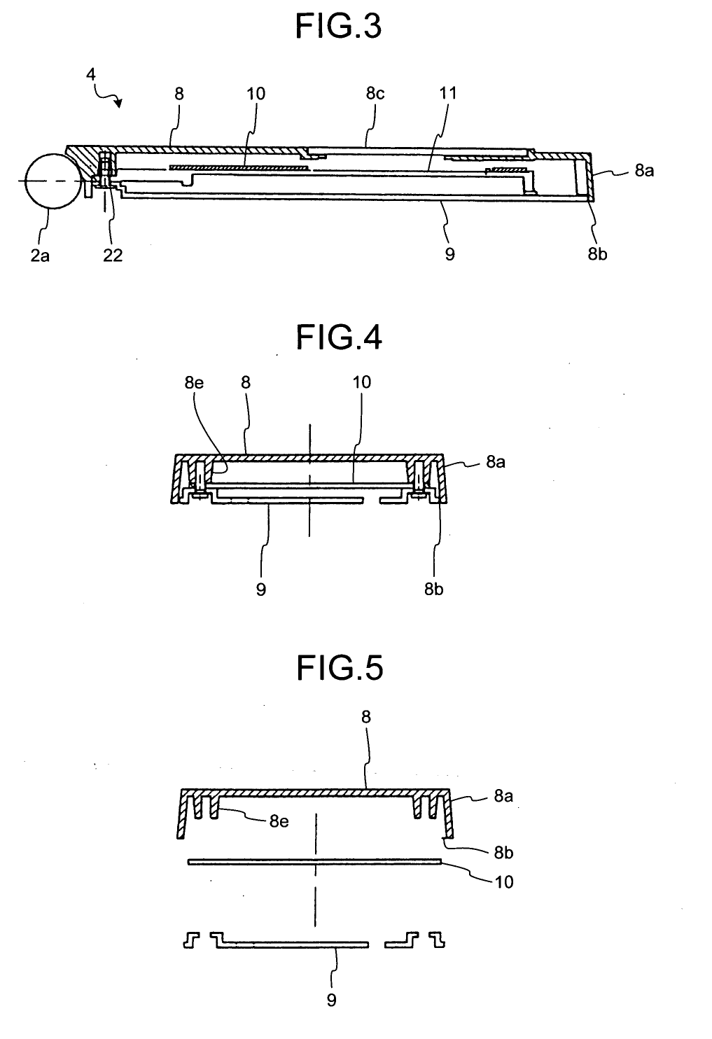

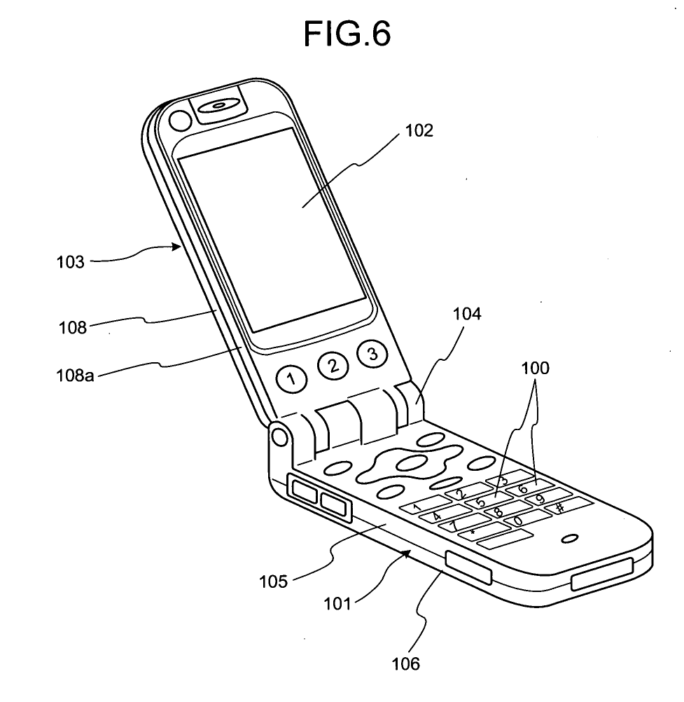

FIG. 2 is an exploded perspective view of the movable-side case 4, FIG. 3 is a cross-sectional side view of the movable-side case 4, FIG. 4 is a partial cross-sectional front view of the movable-side case 4, and FIG. 5 is an exploded front view of the movable-side case 4. The LCD 7 occupies most of the movable-side case 4 so that the display 7a is large and easily viewable. The movable-side case 4 includes a movable rear case 8 that is a box-shaped external case with side walls 8a high enough to house various electronic components of the movable-side case 4 and an opening 8b from which the display 7a is exposed, and a flat panel 9 that is fixed to the opening 8b to cover a front face of the display 7a. The movable-side case 4 excludes the movable front case 107 of the conventional mobile phone.

Internal components of the movable-side case 4 include a circuit board 10 mounted with components such as circuit components for the LCD 7, the LCD 7 having a panel structure held by an LCD holder 11 laminated on the circuit board 10, a sub-LCD module 12 functioning as a supplementary display, a twin camera structure realized by an out-camera module 13 and an in-camera module 14 each having a CCD structure, one-touch keys 15, and a one-touch key module 16. The sub-LCD module 12, which includes a flexible cable 17 that connects the sub-LCD module 12 to the circuit board 10, is attached to an attachment part 8c on a bottom surface of the movable rear case 8, is located on an outer surface of the movable-side case 4, and is covered by a rear panel 19 from outside. The out-camera module 13, which is held by an out-camera holder 18 and connected to the circuit board 10, is attached to an attachment part 8d on the bottom surface of the movable rear case 8, is located on the outer surface of the movable-side case 4, and is covered by an out-camera panel 20 and a camera cover 21 from outside. The in-camera module 14 is held by a holding part 11a of the LCD holder 11 and connected to the circuit board 10, and used for photographing oneself while watching the display 7a. The panel 9 includes an opening 9a from which the in-camera module 14 is exposed. The one-touch keys 15 and the one-touch key module 16 are used for making a phone call with a one-touch operation by registering telephone numbers frequently used. The one-touch keys 15 are located in an area beneath the display 7a on the movable-side case 4, and are exposed from openings 9b of the panel 9.

The movable rear case 8 faces outside when the movable-side case 4 is folded against the fixed-side case 3, is made of light-weight, high-strength magnesium alloy such as AZ91D, AZ63A, etc., and is made into a box shape by die-cast molding or thixotropic molding to house the components of the movable-side case 4. Openings of the attachment parts 8c, 8d may be formed by a press punching process, for example. A movable-side hinge part 2a of the hinge 2 is provided at an edge of the movable rear case 8.

The panel 9 that faces inside (facing the fixed-side case 3) when the movable-side case 4 is folded against the fixed-side case 3 is made of resin, is large enough to entirely cover the opening 8b, and is fixed together with the circuit board 10 to a boss 8e in the movable rear case 8 by screws 22. At least a part of the panel that covers the display 7a is a transparent part 9c so that the display 7a is visible. Alternatively, the entire panel 9 may also be made of a transparent material.

According to the embodiment, the movable-side case 4 is foldably coupled with the fixed-side case 3, and includes the movable rear case 8 that is a box made of magnesium alloy with the side walls 8a deep enough to house the various electronic components of the movable-side case 4, and the opening 8b from which the display 7a is exposed, and the flat panel 9 made of resin is fixed to the opening 8b to cover the front face of the display 7a. The movable front case 107 of the conventional mobile phone is excluded. Only one box-shaped movable rear case 8 is necessary as the case for the movable-side case 4, and therefore, the number of components is reduced, which leads to cost reduction. The movable rear case 8 is made of light-weight, high-strength magnesium alloy, the height of the side wall 8a is increased by the height of the conventional movable front case 107 so that a sectional secondary moment increases, and the strength of the case is further improved compared to the conventional movable rear case having a split structure.

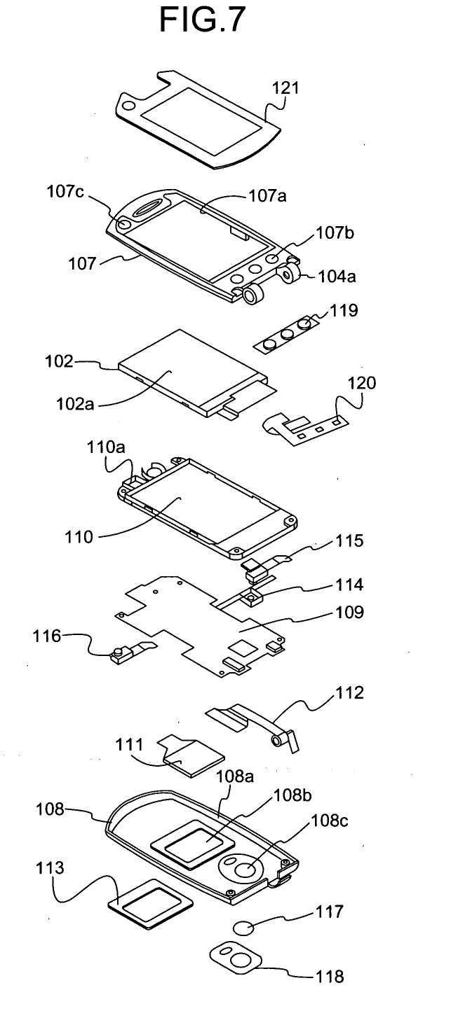

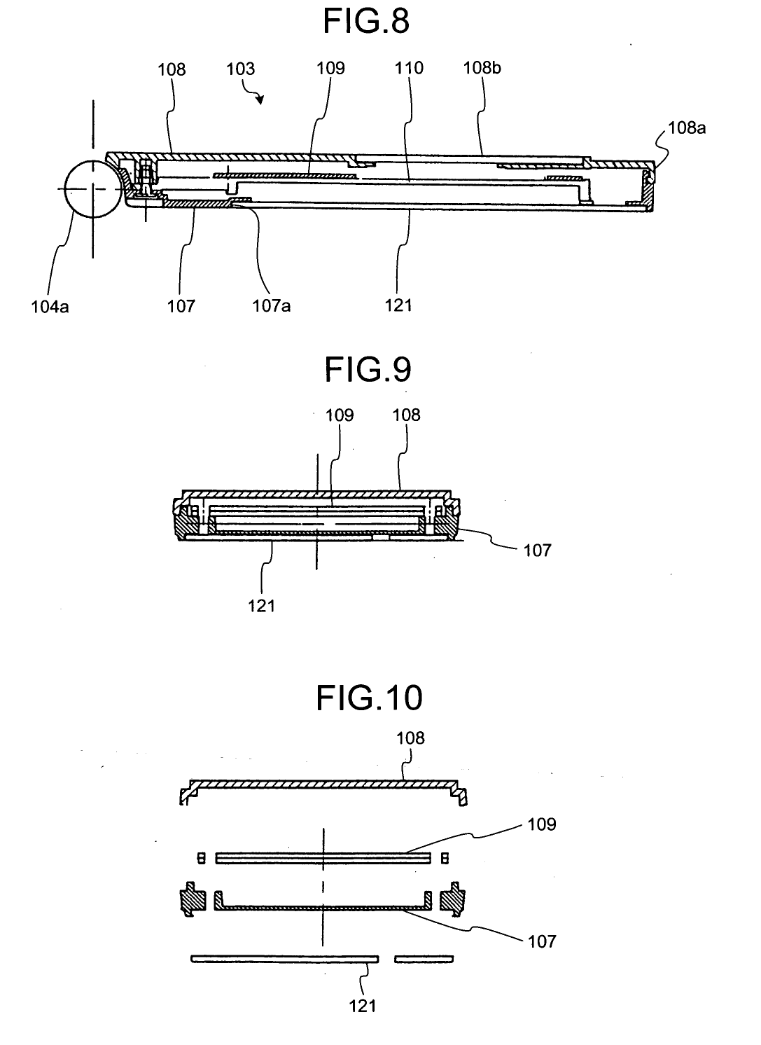

The movable front case 107 of the conventional mobile phone is excluded from the embodiment for the following reason. As shown in FIG. 7, the movable-side case 103 includes the movable front case 107 on the side of the display 102a of the LCD 102. Most of the plane of the movable front case 107 corresponds to the opening 107a from which the display 102a is exposed. The side walls (frame) of the movable front case 107 form part of the movable-side case 103, and therefore, the movable-side case 103 is weak. Moreover, the panel 121 is provided on the opening 107a. Accordingly, the movable front case 107 is an unimportant component of the movable-side case 103, and is thus excluded from the present embodiment. Instead, the side walls of the movable front case 107 are integrated with the side walls 8a of the movable rear case 8, and the panel 9 is made larger than the panel 121 to function as a lid that closes the opening 8b. Consequently, the above effects can be achieved. The panel 9, which is a flat, resin plate fixed to the opening 8b of the movable rear case 8, has a lower strength than the movable rear case 8. However, when the mobile phone 1 is folded at the hinge 2, the movable rear case 8 is located on the outside while the panel 9 is located inside facing the fixed-side case 3. Thus, the panel 9 is reliably protected when the mobile phone 1 is carried or stored.

The embodiment is applied to the mobile phone 1 that folds at the hinge 2; however, the present invention can be applied to any other type of hinge mechanism. Further, the present invention can be applied to a mobile phone in which the movable-side case freely overlaps the fixed-side case by a sliding mechanism or a horizontal plane rotation mechanism.

The embodiment can be applied to mobile terminal devices other than a mobile phone. For example, the embodiment can be applied to compact information processing terminals such as a personal digital assistant (PDA), compact music players, mobile TVs, and mobile game machines.

According to an aspect of the present invention, a number of components and cost are reduced, and strength of the movable-side case is improved.

Furthermore, a panel for covering a display can be used as a lid that covers an external case of the movable-side case.

Moreover, the external case can freely overlap a fixed-side case.

Furthermore, the panel, which is a flat, resin plate fixed to an opening of the external case has a lower strength than the external case. However, when the mobile phone is folded when being carried or stored, the external case is located on the outside while the panel is located inside facing the fixed-side case, so that the panel is reliably protected.

Although the invention has been described with respect to a specific embodiment for a complete and clear disclosure, the appended claims are not to be thus limited but are to be construed as embodying all modifications and alternative constructions that may,occur to one skilled in the art that fairly fall within the basic teaching herein set forth.

What is claimed is:

1. A mobile terminal device, comprising:
a fixed-side case; and
a movable-side case that is coupled to the fixed-side case by a coupler such that the movable-side case freely overlaps the fixed-side case, and that houses electronic components including a display; wherein
the movable-side case includes
an external case that is box-shaped, is made of magnesium alloy, has side walls of a height sufficient for housing the electronic components, and including an opening from which the display is exposed, and
a panel that is flat, covers a displaying surface of the display, and is fixed to the opening.

2. The mobile terminal device according to claim 1, wherein
at least a part of the panel that covers the displaying surface of the display is-transparent.

3. The mobile terminal device according to claim 1, wherein
the external case includes the coupler.

4. The mobile terminal device according to claim 1, wherein
the coupler is a hinge at which the mobile terminal device folds freely.

5. The mobile terminal device according to claim 4, wherein
the external case faces outside when the mobile terminal device is folded.

6. The mobile terminal device according to claim 1, wherein
the display is a liquid crystal display.
